(19) United States
(12) Patent Application Publication
(10) Pub. No.: US 2008/0083737 A1
(43) Pub. Date: Apr. 10, 2008

(54) 12 volts automobile water heater, air maker

(76) Inventor: Nghia Ngo Vu, San Jose, CA (US)

Correspondence Address: THELEN REID BROWN RAYSMAN & STEINER LLP, 2225 EAST BAYSHORE ROAD, SUITE 210, PALO ALTO, CA, 94303, US

(21) Appl. No.: 11/513,397

(22) Filed: Aug. 31, 2006

(51) Int. Cl. H05B 1/02

(52) U.S. Cl. 219/497

(57) ABSTRACT

A new 12 volts direct current (DC) water heater, air maker designs for military vehicles or heavy vehicles; the new unit converts a direct current (DC) from a battery unit and an alternator to an electrical power in a form of Watt or heat energy source uses for heating water for personal use. It also is a new water heater for under ground project, future home, or an air maker to create new oxygen and new hydrogen from water to breath. The new unit has a cylindrical alloy sealed unit or a heat-transferring unit, use for conducting and storing more heat energy in many alloy plates between many thin air gap paths, a process of transferring heat energy occur when water passing through an input port to an output port. The new unit also has an electronic control unit for monitoring and controlling functions of temperatures, safety, and duty cycle of glow plugs.

### BACKGROUND OF THE INVENTION

1. Field of the Invention

Every military vehicle or a big truck has one or two batteries with a capacity from 2,000 amperes to 4,000 amperes, which are stored in a form of chemical energy in the battery's cells. This chemical energy will be converting to electrical energy to supply current for a starter to crank its engine, and supply current to electrical components to operate the vehicle. When vehicle is operating, an alternator is power by the engine pulley. The alternator will generate a current at a rate 200 amperes to 400 amperes to supply all current in the vehicle and recharge electrical energy back to the battery. Every military vehicle or a big truck has an available electrical energy source that be used to convert to electrical power in a form of watts or heat energy source.

The new unit will help troopers, or truck drivers have five to ten gallons of hot water for a hot shower and personal use.

The new unit will be use as an air maker by setting 100° Celsius, making water continuous boiling to break compounds of (H₂O) or water to create new oxygen molecules and new hydrogen molecules or air to breathe in the emergency of a chemical and nuclear war.

The new unit will be prepared for under ground project, where high voltage 110/220 AC (alternating current) are not available or for a safety reason.

The new unit will prepared for future home, for heating water; the system needs an independent battery unit with a capacity of 40,000 amperes to 80,000 amperes to apply for future housing.

If each battery with a capacity of 2,000 amperes, twenty batteries connecting in parallel, they will form a 40,000 amperes battery unit. The battery unit needs to recharge electrical power back from 5000 watts to 20,000 watts per day. Researchers will find a solution, to collect free energies from the Sun by solar cells, from the wind current by wind turbines, from the ocean current by hydraulic turbines, to help future home, storing the free energies in a powerful battery unit for heating water.

2. Description of the Prior Art

There were many water heaters, tank less water heaters, they had invented in the world, and they have been using power sources of a high voltage alternating current (AC): 110 volts to 220 volts, or a higher voltage source, to operate one heater or many heaters from a 1000 watts heater (AC) to a 5000 watts heater (AC). They were very useful electronic water heaters; their main functions have been converting the high voltage alternating current (AC) to electrical power in a form of Watt.

The troopers and the trucks drivers are always have a power source of direct current (DC) voltage of 12 volts or 24 volts (DC) in their vehicle's electrical system and its own alternator, and they cannot use the alternating current (AC) water heaters to operating in their vehicle's electrical system.

A list of the U.S. patents had heating elements working on alternating current (AC) from 110 volts 360 volts (AC).

U.S. Pat. No. 3,909,588 issued Sep. 30, 1975, of Walker; had a name: Temperature control system for electric fluid heater. It had power source operating heating elements were (AC).

U.S. Pat. No. 4,116,016 issued Sep. 26, 1978, of Roop; had a name: Corrosion-resistant liquified gas evaporator. It had a power source operating heating elements were (AC).

U.S. Pat. No. 4,324,207 issued Apr. 13, 1982, of Leuthard; had a name: Energy efficient water heater. It had a power source operating heating elements were (AC).

U.S. Pat. No. 4,484,062 issued Nov. 20, 1984, of Estevez; had a name: Heater structure. It had a power source operating heating elements were (AC).

U.S. Pat. No. 4,534,321 issued Aug. 13, 1985, of Rydborn; had a name: Apparatus for controlling number of boiler. It had a power source operating heating elements were (AC).

U.S. Pat. No. 4,637,349 issued Jan. 20, 1987, of Robinson; had a name: Boiler cycling controller. It had a power source operating heating elements were (AC).

U.S. Pat. No. 4,604,515 issued Aug. 5, 1986, of Davidson; had a name: Tank less electric water heater with staged heating element energization. It had a power source operating heating elements were (AC).

U.S. Pat. No. 4,808,793 issued Feb. 28, 1989, of Hurko; had a name: Tank less electric water heater with instantaneous. It had a power source operating heating elements were (AC).

U.S. Pat. No. 4,825,043 issued Apr. 25, 1989, of Knauss; had a name: Electric continuous flow heater for liquid containers. It had a power source operating heating elements were (AC).

U.S. Pat. No. 4,900,896 issued Feb. 13, 1990, of Maus; had a name: Continuous flow water heater with magnetically-actuated flow switch. It had a power source operating heating elements were (AC).

U.S. Pat. No. 5,020,127 issued May 28, 1991, of Eddas; had a name: Tank less electric water heater. It had a power source operating heating elements were (AC).

U.S. Pat. No. 5,129,034 issued Jul. 7, 1992, of Sydenstricker; had a name: On-demand hot water system. It had a power source operating heating elements were (AC).

U.S. Pat. No. 5,216,743 issued Jun. 1, 1993, of Sietz; had a name: Thermoplastic heat exchanger. It had a power source operating heating elements were (AC).

U.S. Pat. No. 5,325,822 issued Jul. 5, 1994, of Fernandez; had a name: Electric, modular tank less fluids heater. It had a power source operating heating elements were (AC).

U.S. Pat. No. 5,479,558 issued Dec. 26, 1995, of White; had a name: Flow-through tank less water heater with flow switch and heater control system. It had a power source operating heating elements were (AC).

U.S. Pat. No. 5,504,306 issued Apr. 2, 1996, of Russell; had a name: Microprocessor controlled tank less water heater system. It had a power source operating heating elements were (AC).

U.S. Pat. No. 5,866,880 issued Feb. 2, 1999, of Seitz; had a name: Fluid heater with improved heating elements controller. It had a power source operating heating elements were (AC).

U.S. Pat. No. 5,928,546 issued Jul. 27, 1999, of Kramer; had a name: Electrical resistance cooker and automatic circuit controller. It had a power source operating heating elements were (AC).

U.S. Pat. No. 6,080,971 issued Jun. 27, 2000, of Seitz; had a name: Fluid heater with improved heating element controller. It had a power source operating heating elements were (AC).

The disadvantage of alternating current (AC) water heaters are:

All heating elements have immersed in water.

They have a big container, a large housing, and a heavy system.

An alternating current (AC) is always a high voltage system; the system always needs a returning earth wire or ground wire to protect users.

After the (AC) water heaters had installed, they need a power station to supply an alternating current (AC) voltage to operate the water heaters.

All alternating current (AC) water heaters cannot operate on a direct current (DC) power source in a vehicle's electrical system.

All alternating current (AC) water heaters could not create new air or hydrogen and oxygen from water, if the country in a chemical or a nuclear war. US citizens need to evacuate in a sealed room, or an under ground place; they need new air to breathe at least for several hours or several days.

The advantages of the new 12 volts (DC) water heater, air maker:

The new unit was base on the U.S. Pat. No. 7,071,447 issued Jul. 4, 2006, of Nghia; had a name: Automobile coffee maker, by applying the Ceramic sheathed glow plugs for the 12 volts (DC) cooker. In this new patent application the new unit again reused a particular heating element; its name is Ceramic sheathed element glow plug. The glow plug designed for use in a diesel engine, the glow plug has a pellet with a power heating element can carry high current without thermal destroy, to reach a temperature of 800.C. degree in eight seconds and a temperature of 1200.C.degree after sixty seconds. It had a U.S. Pat. No. 6,667,463 issued Dec. 23, 2003, of Terada; had a name Heater, glow plug and water heater.

The new unit has three thermal chip switches; it had a U.S. Pat. No. 4,795,997 issued Jan. 3, 1989, of Fisher; had a name Thermostat for board mounting its size; wide of 10 mm, thick of 4.5 mm, and length of 20 mm. Its power source is a low of 12 to 24 volts direct current (DC); it can apply in many vehicles.

The new unit has many parallel alloy plates were molding between many thin air gap paths for conducting and storing heat energy; these parallel plates create a larger surface area in a small cylindrical alloy sealed unit.

The new unit has the glow plugs not needed to immerse in water.

The new unit can use an old type of glow plug, it has a heating element, wherein made by one coil or two coils, the glow plug designed for use in a diesel engine, the glow plug designed to reach a temperature of 800.C.degree in eight seconds and a temperature of 1000.C.degree after sixty seconds.

The new unit operates with an independent battery unit, where the high voltage alternating current (AC) power source not allows using.

The new unit will be a new useful water heater for under ground project and future home.

The new unit will use as a small electronic device to break compounds of (H₂O) or water to create new hydrogen molecules and new oxygen molecules; their molecules are invisible or could not see. Troopers or people will need it when there is a chemical war or nucleus war. It will install in a sealed mobile unit to protect US citizens. It can be design in a large unit to service many people.

The new unit is very small, its size: five inches wide, ten inches length, and five inches high, its weight is under fifteen pounds; it has a highest technique to serve troopers; truck drivers; under ground project; future home for heating water.

The new unit is very easy to mobile anywhere, very simple operating, and inexpensive to manufacture.

The new unit has an electronic control unit, it generating two out puts independently; monitoring each out put working independently; and monitoring each glow plug working fifty percent of its duty cycle; in result making the unit as reliable and efficiency as alternating current (AC) water heaters.

### SUMMARY OF THE INVENTION

The new 12 volts (DC) water heater, air maker combined of many successful electronic devices in automotive, semiconductor industries to form a newest electronic unit, operating on a direct current (DC) voltage, it can mobilize in many places, and it can apply in many applications. All the electronic components in the new unit were very small, making its size very suitable, very light weight for vehicle's manufactures or vehicle's owners to install or carry in vehicle.

The new unit has an electronic control unit, it controls, and monitors functions accurately by digital waveforms. Each waveform has two states, logic high is eight volts, and a logic low is zero volts.

The new unit will heat water in a shortest time. To serve troopers; serving truck drivers not needed to find a truck stop station for a hot shower; it will be a potential for any under ground project; future home for heating water, and a small electronic device to produce the instant new air for breathing from the water in an emergency.

### BRIEF DESCRIPTION OF THE DRAWINGS

FIG. 1 the 12 volts (DC) water heater, air maker in one unit 1 has:

The cylindrical alloy sealed unit or the heat transfer unit 2.

The electronic control unit on a PC board 6.

Two thick solid ends 3, 5, a glow plug 22, an air gap 20, an alloy plate 21.

FIG. 2 an upright view of the cylindrical alloy sealed unit, sections 3; 4; 5.

FIG. 3 a front view of the two sections 3 and 5 are separate.

FIG. 4 a top views the PC board-connecting the water heater unit.

FIG. 5 is the main schematic circuit and all electronic components in the unit.

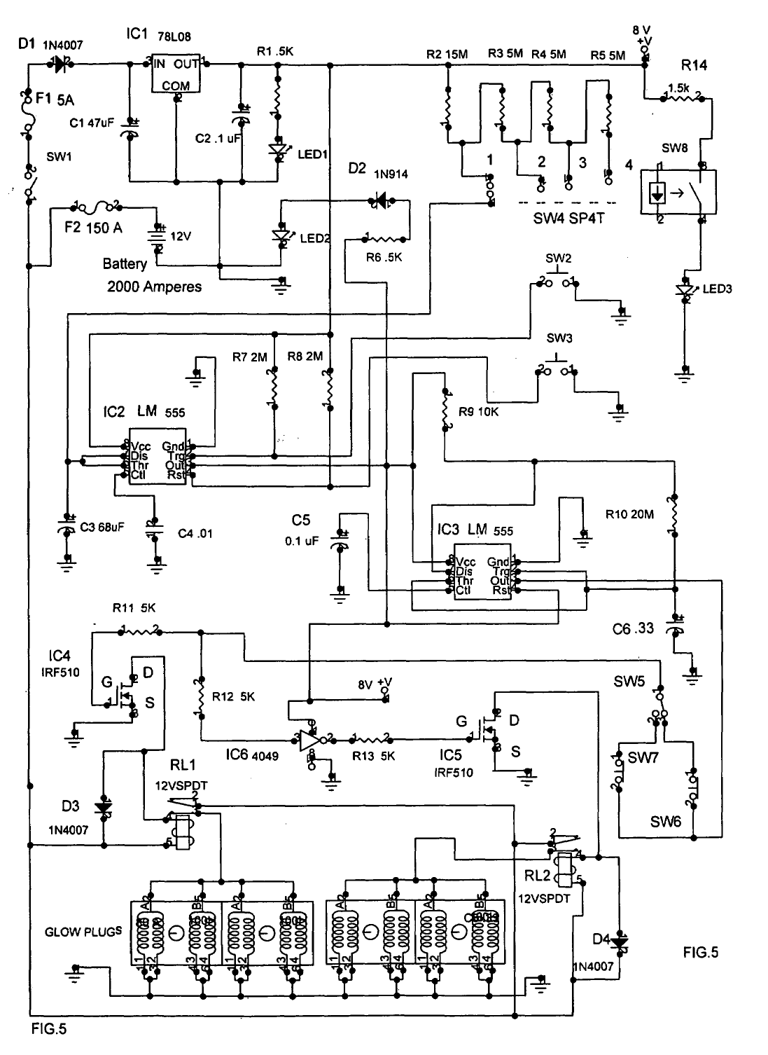

A lists all of the electronic components in FIG. 5

Semiconductors:

Integrated circuit (IC): There are six integrated circuits.

Two integrated circuits: LM 555, they were marked IC2 and IC3.

Two integrated circuits: IRF 510, they were marked IC4 and IC5.

One integrated circuit: LM 7808, it was marked IC1.

One integrated circuit: CD 4049, it was marked IC6.

There are four diodes:

Three diodes: 1N4007, they were marked D1, D3, and D4.

One diode: 1N914, it was marked D2.

There are six capacitors:

One electrolytic capacitor was marked C1, has a value of C1=47 uF.

One electrolytic capacitor was marked C2, has a value of C2=0.1 uF.

One tantalum capacitor was marked C3, has a value of C3=68 uF.

One ceramic capacitor was marked C4, has a value of C4=0.001 uF.

One electrolytic capacitor was marked C5, has a value of C5=0.1 uF.

One tantalum capacitor was marked C6, has a value of C6=0.33 uF.

There are fourteen resistors:

One resistor was marked R1, has a value of R1=1.5 Kilo-ohm.

One resistor was marked R2, has a value of R2=15 Mega-ohm.

One resistor was marked R3, has a value of R3=5 Mega-ohm.

One resistor was marked R4, has a value of R4=5 Mega-ohm.

One resistor was marked R5, has a value of R5=5 Mega-ohm.

One resistor was marked R6, has a value of R6=0.5 Kilo-ohm.

One resistor was marked R7, has a value of R7=2 Mega-ohm.

One resistor was marked R8, has a value of R8=2 Mega-ohm.

One resistor was marked R9, has a value of R9=10 Kilo-ohm.

One resistor was marked R10, has a value of R10=20 Mega-ohm.

One resistor was marked R11, has a value of R11=5 Kilo-ohm.

One resistor was marked R12, has a value of R12=5 Kilo-ohm.

One resistor was marked R13, has a value of R13=5 Kilo-ohm.

One resistor was marked R14, has a value of R14=1.5 Kilo-ohm

Light-Emitting Diode (LED):

There are three LEDs.

One red LED was marked LED1: indicating when glow plugs are operating.

One green LED was marked LED2: indicating when the unit has power.

One yellow LED was marked LED3: indicating when there is no water in the cylindrical metal alloy unit.

Other electronic components:

There are two fuses:

One fuse was marked F1; it has a value of F1=5 amperes.

One fuse was marked F2; it has a value of F2=150 amperes.

There are eight switches:

One switch was marked (SW1) for turning on or turning off power for the electronic control unit; its contacts are single pole single throw (SPST)

One momentary switch was marked (SW2) uses for to start the glow plugs.

One thermal chip switch was marked (SW3) for shutting off the glow plugs if the unit is over heat or exceeds 130° C.; its contacts are normal opened.

One timer selector switch was marked (SW4) for selecting timer from fifteen minutes to half an hour; its contacts are singe pole four throw (SP4T)

One temperature selector switch was marked (SW5) for selecting a 40° C. thermal chip switch (SW6) or a 100° C. thermal chip switch (SW7); its contact are single pole two throw (SP2T).

One thermal chip switch was marked (SW6) is a 40° C. chip switch; its contacts are normal closed.

One thermal chip switch was marked (SW7) is a 100° C. chip switch; its contacts are normal closed.

One sensor switch was marked (SW8) for turning on LED 3, when there is no water in the unit; its contacts are normal opened.

There are two relays:

One relay was marked (RL1) for supplying current the eight glow plugs in Bank.NO.1. Its contacts are single pole dual throw (SPDT)

One relay was marked (RL2) for supplying current the eight glow plugs in Bank.NO.2. Its contacts are single pole dual throw (SPDT)

There are sixteen glow plugs:

There are eight glow plugs in Bank. 1. It was marked Bank.NO.1.

There are eight glow plugs in Bank. 2. It was marked Bank.NO.2.

Pins functioning and electrical name in the integrated circuits:

Each LM555 (IC2) or LM555 (IC3) has an electrical name, the CMOS 555 TIMER; each LM555 has eight pins, they were marked:

Pin number 1 is Ground or negative (O volt); Pin number 2 is pin Trigger; pin number 3 is pin Output; pin number four is pin Reset; pin number 5 is pin Voltage control; pin number 6 is pin Threshold; pin number 7 is pin Discharge; pin number 8 is pin Power supply (+8 volts).

Each IRF510 (IC4) or IRF510 (IC5) has an electrical name: N-channel MOSFET; each has three pins; they were marked:

Pin Gate=G; Pin Source=S; Pin Drain=D

One 78L08 (IC1) has an electrical name: Voltage regulator 8 volts; it has three pins; they were marked:

Pin Input (+12 volts)=IN (in put)

Pin Negative or ground=COM (negative)

Pin Out put (+8 volts)=OUT (positive)

One (4049) (IC6) has an electrical name: Hex inverting buffer; it has sixteen pins; they were marked:

Pin number 1 is pin power supply (+8 volts).

Pin number 8 is pin negative or ground.

Pin number 2 is pin OUT put.

Pin number 3 is pin IN put.

In the main schematic, it used only four pins were lists above.

### DETAILED DESCRIPTION OF THE INVENTION

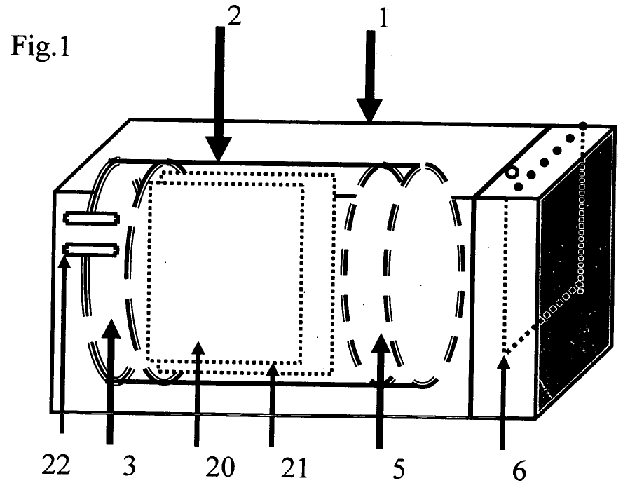

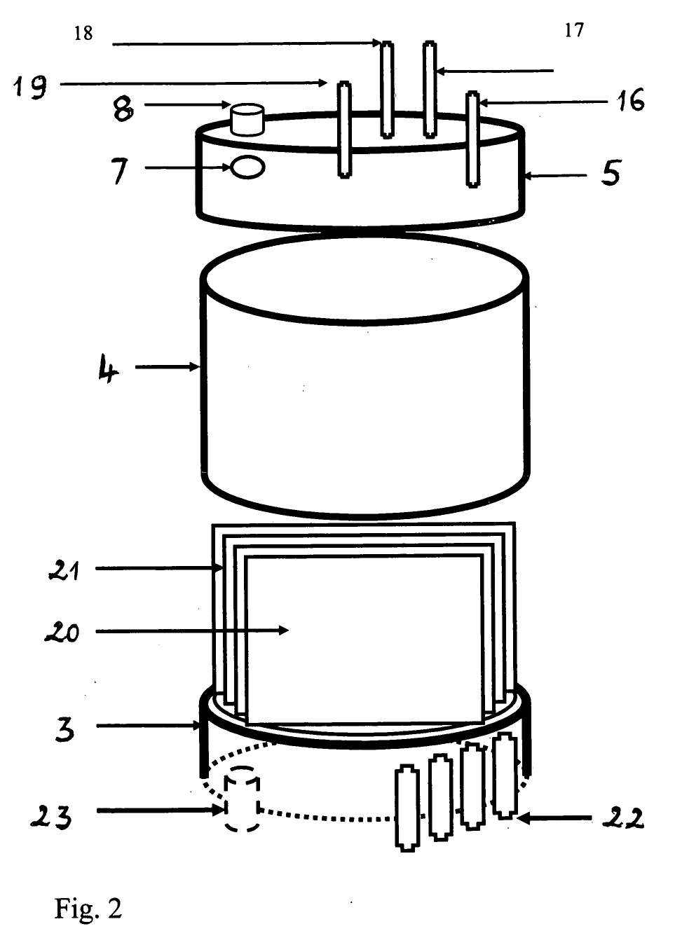

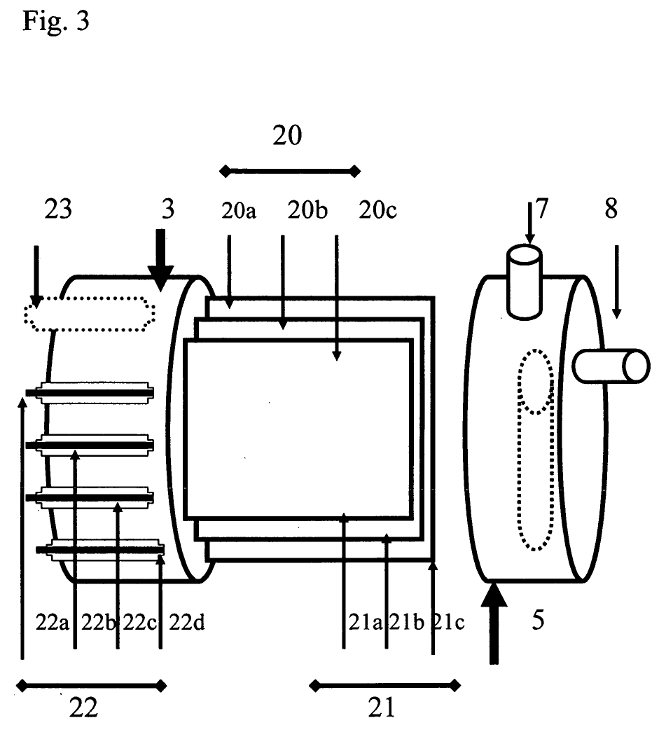

FIG. 1, FIG. 2, FIG. 3:

The new unit has a small metal container 1 to cover the water heater unit. Its size is six inches wide, five inches high, and ten inches length. Under the cover of the unit there is a cylindrical alloy sealed unit or a heat transfer unit 2 in FIG. 1; it has three sections: the two thick solid ends 3 and 5, and the middle section is the cylindrical with two open ends 4 in FIG. 2. Three sections 3; 4; 5 are welded or be screwed together to make a sealed unit 2 in FIG. 1. Next the section 5 in FIG. 1 is the main PC board 6 in FIG. 1; it has an integrated circuit, fabricated on a PC board to control the unit 1 in FIG. 1.

The thick solid end 3 in FIG. 2 working as a heat sink unit, in the bottom, it has many female pre-thread holes for to screw many glow plugs in 22 in FIG. 2. It has four more of glow plugs 22a, 22b, 22c, 22d in FIG. 3; the glow plugs heat the many alloy plates 21 in FIG. 2; there is three more of alloy plates 21a; 21b; 21c in FIG. 3. Near to the glow plug 22 in FIG. 2; there is a one way input port valve 23 in FIG. 2 be connected to the many thin air gap paths in side the cylindrical alloy sealed unit or the heat transfer unit 2 in FIG. 1. Water will pass in one-way input port valve 23 in FIG. 2, and passing out at an out put port 7 in FIG. 2. On top the thick solid end 3 in FIG. 2, it has the thin air gap path 20, and there are three more of thin air gap paths 20a, 20b, and 20c in FIG. 3; between the thin air gap paths are the alloy plates 21a; 21b; 21c in FIG. 3. The alloy plates were mold on top the thick solid end 3 in FIG. 2. Their functioning are conducting and storing heat energy.

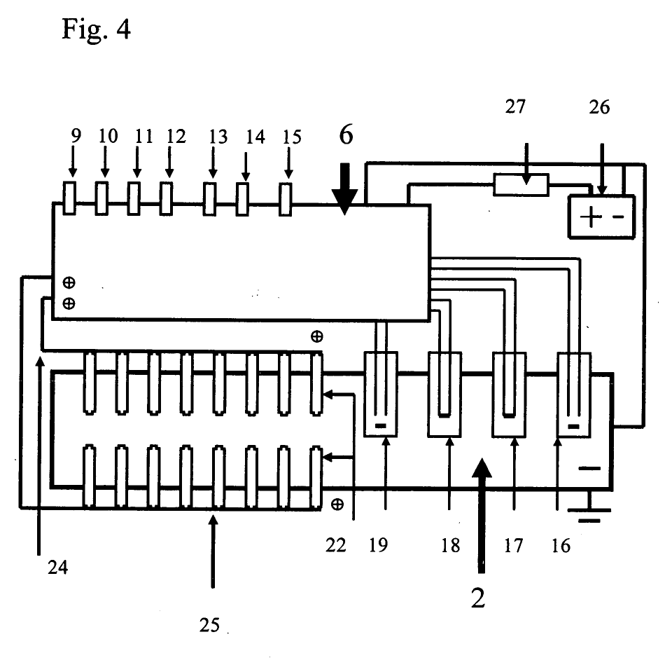

The other thick solid end or section 5 in FIG. 2, it has four female pre-thread holes to screw in the three thermal chip switches 17, 18, 19 in FIG. 2, and a low water sensor 16 in FIG. 2. The low water sensor has a very small magnet bar. The magnet be installed on a float, and the float located inside the cylindrical alloy sealed unit, when there is no water, the float goes to the bottom of the cylindrical alloy sealed. When the magnet gets close to the reed switch sensor, it closing a reed switch inside the low water sensor 16 in FIG. 2, and making the yellow LED 11 in FIG. 4 lit on.

It also has an out put port 7 in FIG. 2; the out put port be connected to the air gap paths in side the cylindrical alloy sealed unit or the heat transfer unit 2 in FIG. 1.

When the new unit be used as a creating new air, a one-way valve unit 8 in FIG. 2 is in used; this one way valve unit allows water to flow in and maintaining water level a half in the cylindrical alloy sealed unit. The one-way valve unit used as an input port; the temperature selector switch 14 in FIG. 4 needs to set 100° C. for breaking compounds of (H₂O) or water. The many alloy plates 21a, 21b, 21c in FIG. 3 will create larger surface area, supplying more heat energy source for breaking compounds of water to form new oxygen and hydrogen molecules; new air will come out at the output port 7 at high speed. If a new 150° C. thermal chip switch be replaced the 100° C. thermal chip switch 18, and the 100° C. thermal chip switch 19 be replace a thermal chip switch 200° C.; the higher temperature be setting, the faster the new air blow out at the out put port 7.

When the new unit be used as a heating water, the temperature selector switch 14 in FIG. 4 will be setting 40° C.; the warm water will come out at the output port 7 in FIG. 2; the one-way valve input port 23 in FIG. 2 is in used. The one-way valve input port unit be screwed in section 3 in FIG. 3 and be connected to the thin air gap paths in side the cylindrical alloy sealed unit.

FIG. 4: The new unit has a PC board 6, the electronic control unit has two out puts: out put Bank NO.1. 24 in FIG. 4 and out put Bank NO.2. 25 in FIG. 4.

Bank.NO.1. 24 has eight glow plugs 22 connected to out put Bank.NO.1.

Bank.NO. 2. 25 has eight glow plugs 22 connected to out put Bank.NO.2.

The cylindrical alloy sealed unit 2 is shared the body frame as the ground line to the negative of the electrical system with a battery unit 26 in FIG. 4; next the battery unit is a safety fuse 27.

A switch 12 in FIG. 4 for turning ON//OFF power of the water heater unit.

A switch 13 in FIG. 4 for starting the glow plugs.

A selector switch 14 in FIG. 4 for selecting 40° C. or 100° C. thermal chip.

A green light emitting diode 9 in FIG. 4, it is on when power is ready.

A red light emitting diode 10 in FIG. 4, it is on when glow plugs be energized

A yellow light emitting diode 11 in FIG. 4, it is on when the water level is low in the cylindrical alloy sealed unit.

A timer-switch 15 in FIG. 4 for selecting time to energize the glow plugs.

FIG. 5 is the main schematic of the new unit.

The electronic components be fabricated on a PC board has:

The integrated circuit 78L08 (IC1) in FIG. 5 reduces 12 volts to eight volts for operating the electronic control unit.

The integrated circuit LM 555 (IC2) in FIG. 5 generates a Monostabe out put pulse, time on be set by formula t=(R2)×(C6).

The timing be selected by the selector switch (SW4) in FIG. 5 or 15 in FIG. 4, it can be set one in four positions (1), (2), (3), (4) to operate the water heater unit from ten to half an hour. It can be set for many hours by replace the capacitor (C3) in FIG. 5, has a larger value of uF unit.

Momentary press the switch (SW2) in FIG. 5 or 13 in FIG. 4 down to start the glow plugs, positive electrons will charge through resistor (R2) in FIG. 5. When the charge in capacitor tantalum (C3) in FIG. 5 is ⅔ of eight volts, the LM 555 (IC2) in FIG. 5 discharges capacitor tantalum (C3) in FIG. 5 to the ground, the Output then goes low or zero volts, resulting the LM 555 (IC2) shutting off the glow plugs.

The integrated circuit LM 555 (IC3) in FIG. 5 generates an Astable output pulse, time on and time off can set by formulas:

Time on=0.693×(R9+R10)×(C6)

Time off=0.693×(R10)×(C6)

Or frequency=1.44/(R9+2R10)×(C6)

The LM 555 (IC2) supplies power and sets time on for the LM 555 (IC3); the LM 555 (IC3) generates a frequency following the formula above.

Each cycle has a half cycle time on and has a half cycle time off.

If one cycle lasting two minutes, a half cycle time on lasting one minute, and a half cycle time off lasting one minute.

During LM 555 (IC3) in FIG. 5 is functioning as an oscillator, a half cycle of an output pulse is a logic high or eight volts and a half cycle of an output pulse is a logic low or zero volts.

The pin Gate=G of the integrated circuit IRF 510 (IC4) in FIG. 5 be connected to the pin Output of LM 555 (IC3). Every time the LM 555 (IC3) has a logic high or eight volts, the IRF 510 (IC4) will turn on relay (RL1) supplying current for the glow plugs in Bank.NO.1.

The pin Gate=G of the integrated circuit IRF510 (IC5) be connected to the pin (# 2) output of the integrated circuit Hex inverting buffer 4049 (IC6). Every time the LM 555 (IC3) has a logic low or zero volts, the pin (# 3) input of the Hex inverting buffer 4049 (IC6) converting a logic low or zero volts to a logic high or eight volts, the IRF 510 (IC5) in FIG. 5 will turn on relay (RL2) supplying current for the glow plugs in Bank.NO.2.

The electronic control unit is continuous generating two outputs and monitoring timing accurately by second.

The timer-selector is (SW4) in FIG. 5 or 15 in FIG. 4.

The thermal chip switch-selector is (SW5) in FIG. 5, if the (SW5) be connected to (SW6) in FIG. 5 or thermal chip switch 17 in FIG. 4, when the water heater unit used as a heating water.

If the (SW5) be connected to (SW7) in FIG. 5 or thermal chip switch 18 in FIG. 4 the water heater unit used as a creating new air.

The LM 555 (IC2) in FIG. 5 shutting off the glow plugs when time is expired. If the new unit is over heat, the switch (SW3) in FIG. 5 or 19 in FIG. 4 will connect pin Reset of the integrated circuit LM 555 (IC2) to ground, resulting, it shutting off all the glow plugs.

The (SW8) in FIG. 5 is a low water sensor, when the float in the cylindrical alloy unit goes down a magnet bar will close the switch (SW8) or 16 in FIG. 4. The 26 in FIG. 4 is a battery unit; the 27 in FIG. 4 is 150 amperes fuse.

How it works: Turn switch (SW1) in FIG. 5 on; the new unit has power; setting switch (SW5) in FIG. 5 to select (SW6) in FIG. 5 at a temperature of 40° C. to heat water; set the timer switch (SW4) in FIG. 5 at position (4) or delay time on for half an hour; press start switch (SW2) in FIG. 5 and release. The LM555 (IC2) in FIG. 5 will start its functions controlling time delays on for the (IC3) and (IC6) in FIG. 5; the internal circuit LM555 (IC2) will set pin output high or eight volts. Pin output of (IC2) will supply power for (IC3); the (IC3) will generate first output digital waveforms to control glow plugs in Bank.NO. 1. At the same time the (IC6) will generate second output digital waveforms to control glow plug in Bank.NO. 2.

Each output digital waveforms allowing each Bank.NO.1 or Bank.NO.2. is energized at a rate fifty percent its duty cycle. The (IC2) will automatic shutting off all glow plugs when time is expired.

If the unit is over heat, the switch (SW3) connects pin reset of (IC2) to ground, (IC2) self-shutting off all glow plugs or reset the (IC2).

The relay (RL1) supplies current for the glow plugs in Bank.NO.1.

The relay (RL2) supplies current for the glow plugs in Bank.NO. 2.

Electrical power formulas:

P=VI with V=12 volts, and I=120 Amperes

P=(12)(120)=1440 Watts.

Where P is power in unit of Watts.

I is current in unit of Amperes.

V is voltage in unit of volts.

According to formulas, sixteen glow plugs will generate 1440 Watts.

All glow plugs need to program operating at a rate fifty percent duty cycle to prevent burn out glow plugs.

The formula below relating to heat energy using to break interlink compounds of (H₂O) or water to form oxygen and hydrogen molecules; the same as the Sun creates new air for the atmosphere every day by heated ¾ surface of Ocean; rivers; clouds and all living plants on the earth surface.

2H₂0+HEAT ENERGY=2H₂+O₂

Or 2H₂O+(572 KJ)=2H₂+O₂

Two molecules of water need 572 K joules to produce two molecules of the diatomic hydrogen gas and one molecule of the diatomic oxygen gas. It is first formula to calculate the amount of heat energy to have new air.

The second formula below used to calculate the quantity of heat energy required to raise the temperature of 1 Kg of water by 1° Celsius.

Q=mc(t₂−t₁)joules

And water has a specific heat capacity of: c=4190 J/(Kg° C.). End:

What a claim is:

1. An apparatus operated by a direct current (DC) power source for heating water or creating oxygen and hydrogen molecules from water comprising:
(a) a cylindrical alloy sealed unit with two thick solid ends, wherein on top the thick solid end has many parallel alloy plates were molding between many thin air gap paths, and the bottom of the thick solid end has many female pre-thread holes configured to screw glow plugs in,
(b) the many alloy plates creating a larger surface area use for faster conducting and storing more heat energy in a larger surface area, and the many thin air gap paths use for transferring the heat energy when water passing through the many thin air gap paths from an input port,
(c) the water heater unit including at least one ceramic sheathed glow plug, designed for use in a diesel engine, wherein the glow plug has a pellet with a power heating element, and wherein the glow plug is designed to reach a temperature of 800°.C. in eight seconds and a temperature of 1200°.C. after sixty seconds.

2. The further of claim 1, wherein the heating element includes a coil.

3. The apparatus of claim 1, wherein has a liquid of H₂0 molecules, and hydrogen molecules, and oxygen molecules.

4. The apparatus of claim 1; further comprising an electronic control unit capable of shutting off at least one glow plug when the temperature exceeds 130° Celsius.

5. The apparatus of claim 1, further comprising an electronic control unit capable of shutting off at least one glow plug when the temperature exceeds 100° Celsius.

6. The apparatus of claim 1, further comprising an electronic control unit capable of shutting off at least one glow plug when the temperature exceeds 40° Celsius.

7. The apparatus of claim 1, further comprising an electronic control unit capable of monitoring each glow plug is energized a rate of fifty percent of its duty cycle.

8. A method operated by a direct current (DC) power source for heating water or creating oxygen and hydrogen molecules from water comprising:
providing an apparatus having
(a) a cylindrical alloy sealed unit with two thick solid ends, wherein on top the thick solid end has many parallel alloy plates were molding between many thin air gap paths, and the bottom of the thick solid end has many female pre-thread holes configured to screw glow plugs in,
(b) the many alloy plates creating a larger surface area use for faster conducting and storing more heat energy in a larger surface area, and the many thin air gap paths use for transferring the heat energy when water passing through the many thin air gap paths from an in put port,
(c) the water heater unit including at least one ceramic sheathed glow plug, designed for use in a diesel engine, wherein the glow plug has a pellet with a power heating element, and wherein the glow plug is designed to reach a temperature of 800°.C. in eight seconds, and a temperature of 1200°.C. after sixty seconds.

9. The further of claim 8, wherein the heating element includes a coil.

10. The method of claim 8, wherein has a liquid of (H₂0) molecules, and hydrogen molecules, and oxygen molecules.

11. The method of claim 8, further comprising an electronic control unit capable of shutting off at least one glow plug when the temperature exceeds 130° Celsius.

12. The method of claim 8, further comprising an electronic control unit capable of shutting off at least one glow plug when the temperature exceeds 100° Celsius.

13. The method of claim 8, further comprising an electronic control unit capable of shutting off at least one glow plug when the temperature exceeds 40° Celsius.

14. The method of claim 8, further comprising an electronic control unit capable of monitoring each glow plug is energized a rate of fifty percent of its duty cycle.
